(19) United States
(12) Patent Application Publication
(10) Pub. No.: US 2009/0167960 A1
(43) Pub. Date: Jul. 2, 2009

(54) PICTURE PROCESSING APPARATUS

(75) Inventor: Hajime Miyasato, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/295,210

(22) PCT Filed: Mar. 29, 2007
(86) PCT No.: PCT/JP2007/056845

§ 371 Date: Oct. 20, 2008

(30) Foreign Application Priority Data
Mar. 29, 2006 (JP) 2006-090096

(51) Int. Cl. H04N 9/64

(52) U.S. Cl. 348/714; 348/E07.091

(57) ABSTRACT

Still shots are detected from a video signal by still shot detection means, and a representative image of the program is accordingly specified by representative image selection means, and as a result, an image that well reflects the contents of the program can be efficiently acquired. As a result, it differs from the case where a representative image is specified from superimposed text alone, in that a representative image that has substantive meaning can be efficiently acquired.

### CROSS-REFERENCE TO RELATED APPLICATION

This application is based on Japanese Patent Application No. 2006-090096 filed on Mar. 29, 2006, the contents of which is incorporated hereinto by reference.

### BACKGROUND OF THE INVENTION

1. Field of the Invention

The present invention relates to a picture processing apparatus that specifies a representative image according to the contents of the program that is the object of processing.

2. Description of the Related Art

In recent years, TV recording devices represented by DVDs (digital versatile disks) and HDDs (hard disk drives) have come to be able to record and store many programs at once, following an increase in capacity of storage media. In these devices, program menu functions that select one (or a plurality of) representative image(s) that represent(s) the contents of each program and line these up on the screen are widely used.

In general, images such as TV programs are expressed as movies by continuously displaying many different frames one at a time, and each frame that constitutes the movie is called a frame image. Normally, the above-described representative image is generated by extracting one (or a plurality of) frame image(s) from the movie of the program.

As this type of representative image generation apparatus that generates a representative image, there is an apparatus according to JP, A, 2003-298983 (page 6, FIG. 9), for example. This representative image generation apparatus has superimposed text detection means, and as the representative image it uses the frame image in which superimposed text is inserted at the point when said superimposed text is detected.

In the above-described prior art, a frame image in which superimposed text is inserted is used as the representative image, but in programs in which a lot of superimposed text is displayed, such as news programs, for example, there are many representative images that can be selected, and there is the possibility that the one selected does not well reflect the contents of the program.

The above problem is given as one example of the problems to be solved by the present invention.

### SUMMARY OF THE INVENTION

To overcome the problem mentioned above, the invention according to claim 1 provides a picture processing apparatus comprising: still shot detection means for detecting a still shot from a video signal provided in the program to be processed; specification means for specifying a representative image of the program based on the detection results of the still shot detection means; and output means for outputting a signal corresponding to the representative image specified by the specification means.

### BRIEF DESCRIPTION OF THE DRAWINGS

FIG. 1 is an explanatory diagram conceptually illustrating the functional contents of the recording apparatus of an embodiment of the present invention.

FIG. 2 is a functional block diagram illustrating the functional configuration of the recording apparatus illustrated in FIG. 1.

FIG. 3 is a flowchart illustrating the control procedure executed by the system control unit illustrated in FIG. 2.

FIG. 4 is a functional block diagram illustrating the functional configuration of the image processing unit illustrated in FIG. 2.

FIG. 5 is a drawing illustrating an example of the parameters of still shot information.

FIG. 6 is a drawing illustrating an example of the parameters of superimposed text information.

FIG. 7 is a flowchart illustrating in detail the procedure of step S200 illustrated in FIG. 3B.

FIG. 8 is a functional block diagram illustrating the functional configuration of the image processing unit in the case where the picture information itself of the representative image is generated and output.

FIG. 9 is a flowchart illustrating the control procedure executed by the system control unit in the case where specification of the representative image is performed when writing to the HDD.

FIG. 10 is a functional block diagram illustrating the functional configuration of the recording apparatus in the case where recording directly to disk is performed while specification of the representative image is being performed.

FIG. 11 is a flowchart illustrating the control procedure executed by the system control unit in the case where recording directly to disk is performed while specification of the representative image is being performed.

FIG. 12 is a functional block diagram illustrating the functional configuration of the recording apparatus in the case where the representative image is printed.

FIG. 13 is a functional block diagram illustrating the functional configuration of the image processing unit in the case where the representative image is printed.

FIG. 14 is a flowchart illustrating the control procedure executed by the system control unit in the case where the representative image is printed.

FIG. 15 is a drawing for explaining the procedure by which chapters and their representative images are determined from the picture information of one program, and a drawing illustrating an example of a chapter menu.

FIG. 16 is a drawing illustrating an example of the case where the threshold value is varied depending on the program, in the case where the threshold value of still shot detection is varied depending on the program.

### DETAILED DESCRIPTION OF THE PREFERRED EMBODIMENTS

An embodiment of the present invention will be described below, with reference to the drawings.

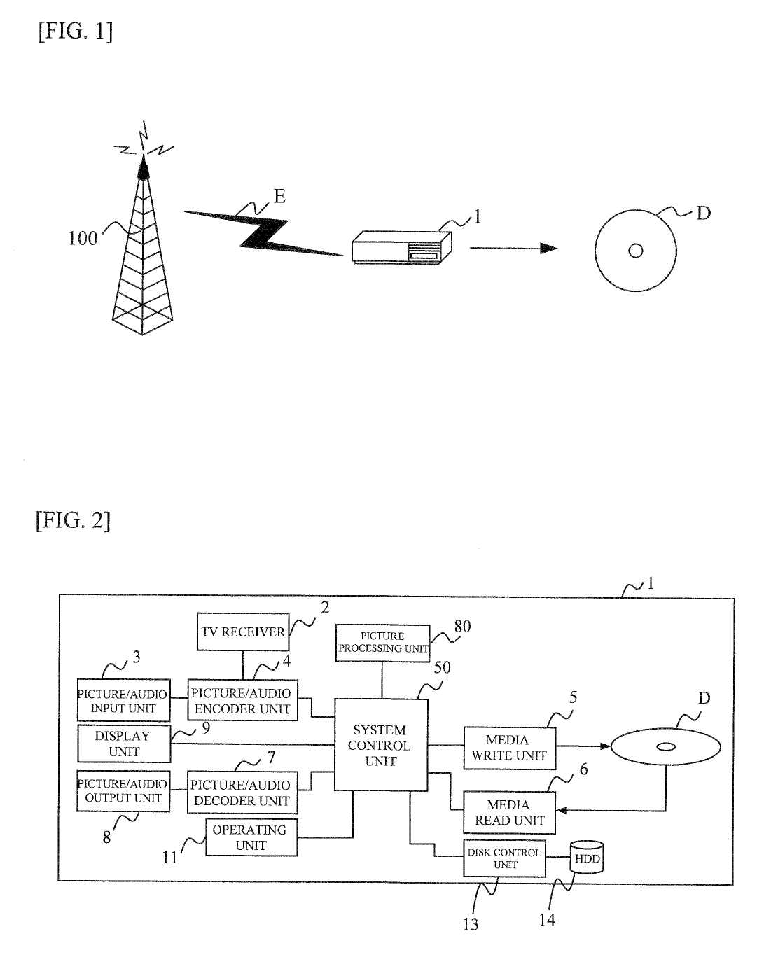

FIG. 1 is an explanatory diagram conceptually illustrating the functional contents of the recording apparatus 1 of the present embodiment. In FIG. 1, the recording apparatus 1 receives a broadcast wave E of a television broadcast from an electrical wave supply source 100 (broadcast station, relay station, base station or satellite and the like) (however, the broadcast signal can also be received via a wire such as a cable, and is not limited to electrical waves; similarly hereinafter), and the received program image is temporarily written to a hard disk using a known hard disk drive, after which it is read from the hard disk and recorded to a recording medium D such as an optical disk (for example, writeable DVD-R, DVD-RW, DVD-RAM and the like).

FIG. 2 is a functional block diagram illustrating the functional configuration of the above-described recording apparatus 1. In FIG. 2, the recording apparatus 1 comprises a system control unit 50 that controls the entire recording apparatus 1; a TV receiver 2 that receives the above-described broadcast wave E via an antenna (not shown) and outputs a video signal and audio signal; a picture/audio encoder unit 4 that performs A/D conversion of the picture/audio input (or picture/audio input from a picture/audio input unit 3 equipped with an external input terminal) from the TV receiver 2; a media write unit 5 that irradiates a recording medium D with a laser beam for writing data by supplying as a drive signal to the optical pickup (not shown) an encoded picture/audio signal from the picture/audio encoder unit 4 that was processed into a predetermined format by the above-described system control unit 50; a media read unit 6 that generates a detection signal from the interception output of the reflected beam intercepted when the above-described optical pickup irradiates the recording medium D with a laser beam for reading data; a picture/audio decoder unit 7 that decodes and performs D/A conversion of the picture/audio signal that was generated by the media read unit 6 and processed into a predetermined format by the above-described system control unit 50; a picture/audio output unit 8 equipped with an external output terminal that outputs the analog picture/audio signal output from the picture/audio decoder unit to a speaker or display apparatus such as a CRT, plasma display, liquid crystal display and the like (not shown); an operating unit 11 (or, if a remote control is used, an operating signal input unit that inputs an operating signal from the remote control; similarly hereinafter) by which an operator performs various input and selection operations; a hard disk drive 14 equipped with a known hard disk and equipped with data read/write functions to the hard disk; a disk control unit 13 that controls data read/write to the hard disk drive 14 based on the control signal of the system control unit 50; a picture processing unit 80 that processes the video signal read from the hard disk drive 14 and specifies a representative image (thumbnail), and generates a signal that corresponds to this representative image; and a display unit 9 for displaying the representative image and the like specified by the picture processing unit 80.

Furthermore, “representative image” means a frame image that well reflects the programs pertaining to the received broadcast wave E, and “frame image” means each frame that constitutes the movie of the TV program and the like by continuously displaying many different frames one at a time.

The operating unit 11 outputs various command signals that correspond to the operations of the operator. These command signals are input to the system control unit 50, and the system control unit 50 controls the entire recording apparatus 1 according to a preset computer program.

The picture processing unit 80 is connected to the system control unit 50, and when the picture information of the broadcast wave E received by the TV receiver 2 and temporarily stored on the hard disk of the hard disk drive 14 is read from the hard disk by the system control unit 50 in order to write it to the recording medium D, the picture processing unit 80 specifies the representative image from the plurality of frame images contained in the picture information, and it outputs the specification signal for specifying the representative image (frame instruction signal) to the system control unit 50.

By being configured as described above, the recording apparatus 1 can record video signals and audio signals input from the above-described TV receiver 2 or the above-described picture/audio input unit 3 to a recording medium D, and additionally, it can output the video signals and audio signals recorded to the recording medium D externally via the picture/audio output unit 8. Also, as described above, when recording to the above-described recording medium D, the representative image is specified by the picture processing unit 80 based on the contents of the program images received via the broadcast wave E, and the signal that corresponds to this representative image is also recorded to the recording medium D.

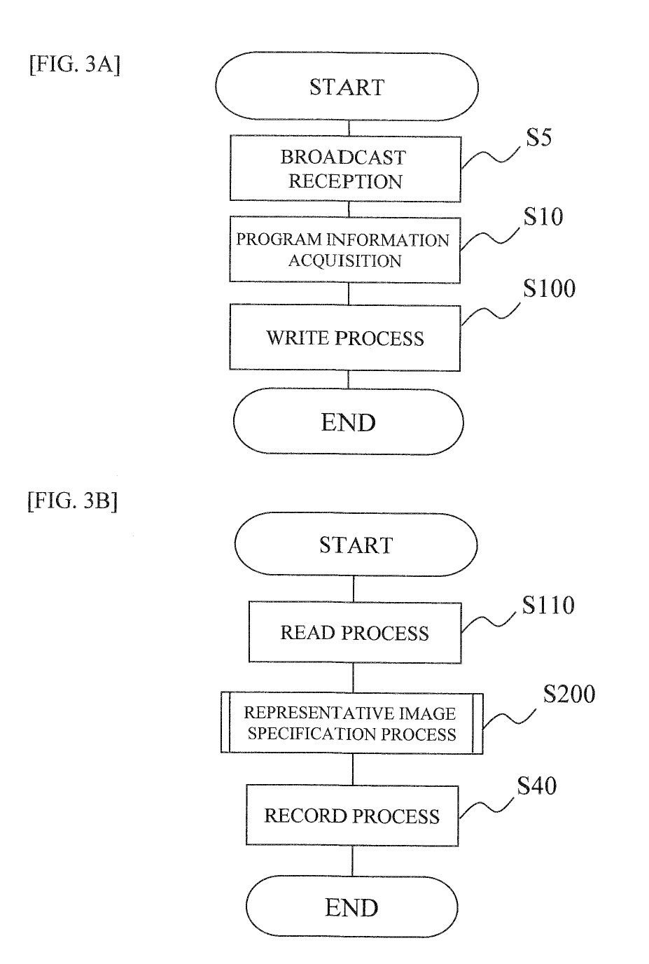

FIG. 3A and FIG. 3B are flowcharts illustrating the control procedure executed by the above-described system control unit 50.

FIG. 3A illustrates the procedure up until writing to the hard disk is performed by the above-described hard disk drive 14. In FIG. 3A, the flow is started when, for example, an operation is performed via the operating unit 11 to receive a television broadcast and record it to the recording medium D.

First, in step S5, a video signal and an audio signal that were received by the TV receiver 2 and encoded by the picture/audio encoder unit 4 are taken in.

After that, in step S10, predetermined information (for example, channel number, program genre, program name, broadcast time band, program length, electrical wave type and the like) pertaining to the program to be received and recorded according to channel and program selection operations by the operator on the above-described operating unit 11 is acquired. At this time, if an electronic program guide (EPG) is used, for example, the predetermined information pertaining to the above-described program can also be acquired in response to the fact that the operator specified the region (box) of the program via the operating unit 11 in the state where the electronic program guide was displayed on the display unit 9 or separately-provided display. Also, the predetermined information pertaining to the above-described program can also be acquired from the video signal or audio signal and the like received in step S5, rather than from an operating signal.

Then, the flow moves to step S100, where a control signal is output to the disk control unit 13, and the picture information and audio information corresponding to the video signal and audio signal received and encoded by the picture/audio encoder unit 4 in step 5 are written to the hard disk by the hard disk drive 14. When step S100 ends, the flow of FIG. 3A ends.

After that, the flow of FIG. 3B is started when, for example, an operation is performed by the operator via the operating unit 11 to record to the recording medium D. First, in step S110, a control signal is output to the disk control unit 13, and the picture/audio information that was written and saved to the hard disk in the above-described step S100 is read from the hard disk by the hard disk drive 14. After that, the flow moves to step S200.

In step S200, a control signal is output to the picture processing unit 80, and a representative image specification process is performed, in which a representative image is specified from the plurality of frame images contained in the picture information within the picture/audio information read from the above-described hard disk.

After that, in step S40, the recording process is executed, in which a control signal is output to the media write unit 5 based on the record instruction signal (described below) generated by the picture processing unit 80, and a laser beam is output from the above-described optical pickup, and picture information and audio information corresponding to the video signal and audio signal received and encoded by the picture/audio encoder unit 4 in step S5, as well as the representative image information (specification information for specifying a representative image) generated by the picture processing unit 80, are written to the recording medium D. With this, the flow ends.

Furthermore, while the above describes the case where the representative image (here, specification information for specifying a representative image) selected by the picture processing unit 80 is set automatically and written as is to the recording medium D, the present invention is not limited thereto. That is, recording can also be performed by setting the representative image after the confirmation of the operator is obtained, for example. In this case, after the representative image specification process of the above-described step S200, a display control signal (display signal) is output to the display unit 9 and the representative image specified in the representative image specification process is displayed on the display unit 9, and the representative image is set in response to an operation by the operator who sees the display of the representative image on the display unit 9, either in the case where he selects (confirms) “write OK” for one representative image, for example, or in the case where he selects any one of the representative images if there are a plurality of representative images, for example, and then the flow moves to the recording process of step 40.

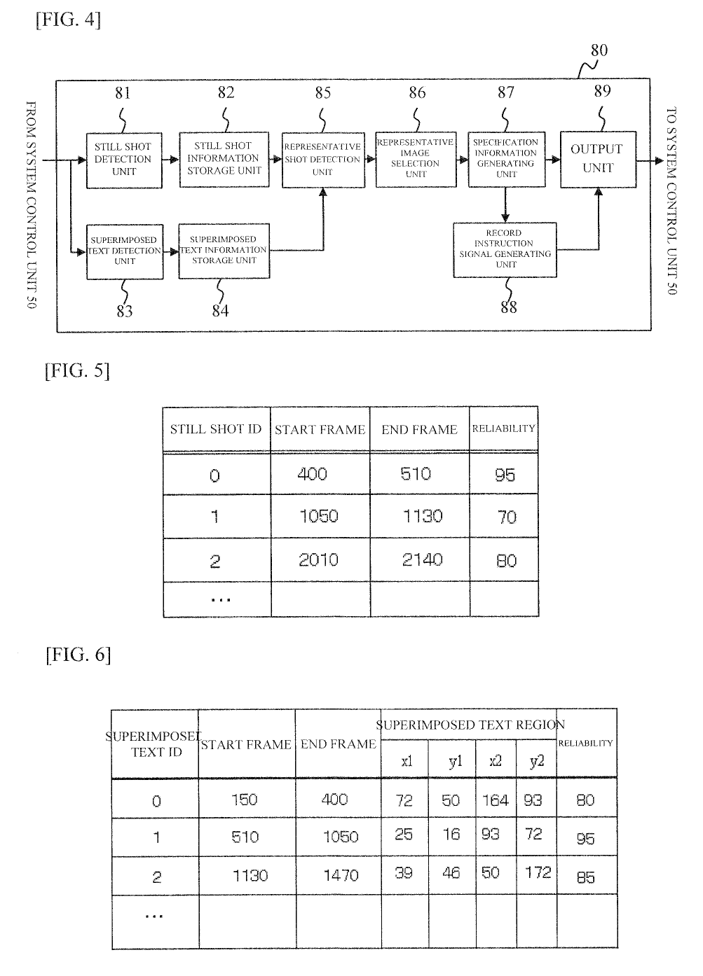

FIG. 4 is a functional block diagram illustrating the functional configuration of the picture processing unit 80 illustrated in FIG. 2. As illustrated in FIG. 4, the picture processing unit 80 comprises still shot detection means 81, a still shot information storage unit 82, superimposed text detection means 83, a superimposed text information storage unit 84, representative shot detection means 85, representative image selection means 86, specification information generating means 87, record instruction signal generating means 88, and output means 89.

First, picture information of the broadcast wave E that was read from the hard disk of the hard disk drive 14 by the system control unit 50 and input into the picture processing unit 80 is input into the still shot detection means 81. In the still shot detection means 81, the signal of the picture information that was input is analyzed, and a still shot is detected. Furthermore, “shot” means a collection of frames that are continuous in time within an image, and “still shot” means a shot in which the frame images contained in a shot change little over a fixed period of time. The still shot detection method itself is known. For example, detection can be performed by a method such as accumulating the luminance differences in pixels between frames that are adjacent in time, or performing threshold comparison of the differences in luminance histograms. Furthermore, if there are a plurality of regions in which there is little change in the frame image in one program, a plurality of still shots are detected.

In the above-described still shot detection means 81, the detected still shot information is stored in a still shot information storage unit 82. The still shot information storage unit 82 is constructed of memory and the like of the picture processing unit 80, and an external HDD and the like can also be used. An example of the parameters of still shot information is illustrated in FIG. 5. As illustrated in FIG. 5, in addition to still shot start/end frames, reliability calculated based on the results of threshold comparison and the like can also be added. Furthermore, this still shot information is saved in connection with various detected information of the TV image (program name, broadcast date and the like).

On the other hand, picture information of the broadcast wave E that was read from the hard disk of the hard disk drive 14 by the system control unit 50 and input into the picture processing unit 80 is input into the superimposed text detection means 83 as well. In the superimposed text detection means 83, the signal of the picture information that was input is analyzed, and superimposed text is detected using a known superimposed text detection method.

In the above-described superimposed text detection means 83, the detected superimposed text information is stored in a superimposed text information storage unit 84. The superimposed text information storage unit 84 is constructed of memory and the like of the picture processing unit 80, and an external HDD and the like can also be used. An example of the parameters of superimposed text information is illustrated in FIG. 6. As illustrated in FIG. 6, in addition to superimposed text start/end frames, coordinates that express the superimposed text region (for example, in the case where the superimposed text region is a rectangle, x1 and y1 in the drawing indicate the apex at the top left of the superimposed text region, and x2 and y2 indicate the coordinates of the apex at the lower right of the superimposed text region), reliability or character recognition results and the like (not shown) can also be added. Furthermore, this superimposed text information is saved in connection with various detected information of the TV image (program name, broadcast date and the like).

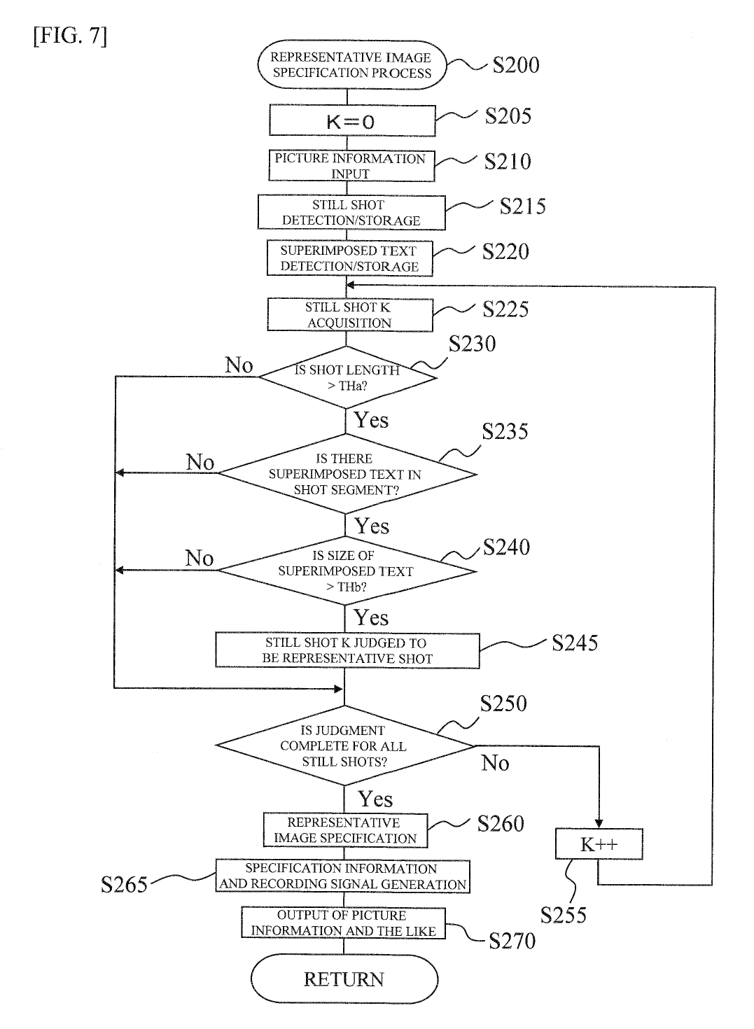

The representative shot detection means 85 detects the representative shot based on still shot information stored in the above-described still shot storage unit 82 and superimposed text information stored in the above-described superimposed text information storage unit 84. In the present embodiment, a still shot whose shot length is longer than a predetermined value and whose size of superimposed text in the still shot is larger than a predetermined value is detected as a representative shot (refer to below-described FIG. 7). Furthermore, if a plurality of still shots that satisfy this condition are present, a plurality of representative shots are detected.

The representative image selection means 86 selects as the representative image a frame image in the representative shot detected by the above-described representative shot detection means 85. In the present embodiment, any frame image in the representative shot can be selected because the representative shot is a still shot and the frame images that comprise it are nearly the same images. Furthermore, the frame image after a predetermined time has elapsed from the start of the shot can be selected, or the frame image at a predetermined number of frames from the start of the shot can be selected, for example. Also, in the case where a plurality of representative shots are detected by the representative shot detection means 85, which representative shot the representative image is selected from is not particularly stipulated in the present embodiment, but, for example, it can be selected by setting a fixed condition, such as the one nearest the start of the program, the one with the longest shot length or the one with the largest superimposed text size.

The specification information generating means 87 generates a frame specification signal that indicates which frame image in the representative shot is the selected representative image, as the specification information for specifying the representative image selected by the above-described representative image selection means 86.

The record instruction signal generating means 88 generates a record instruction signal (first record instruction signal) for recording the specification information generated by the above-described specification information generating means 87 to the recording medium D in connection with the corresponding video signal.

The output means 89 outputs to the system control unit 50 the specification information generated by the above-described specification information generating means 87 and the record instruction signal generated by the record instruction signal generating means 88.

FIG. 7 is a flowchart illustrating in detail the procedure (representative image specification process) of step S200 illustrated in FIG. 3B.

In FIG. 7, first, in step S205, a variable K that counts the ID number of the still shot information (refer to above-described FIG. 5) is initialized to 0. Then, in the next step S210, a control signal is output to the disk control unit 13, and picture/audio information is read from the hard disk of the hard disk drive 14, and the picture information within it is input to the picture processing unit 80.

In the next step S215, a control signal is output to the picture processing unit 80, and the above-described input picture information signal is analyzed by a known method by the still shot detection means 81, and the still shot is detected, and additionally, the detected still shot information is stored in the still shot information storage unit 82.

In the next step S220, a control signal is output to the picture processing unit 80, and the above-described input picture information signal is analyzed by a known method by the superimposed text detection means 83, and the superimposed text is detected, and additionally, the detected superimposed text information is stored in the superimposed text information storage unit 84.

In the next step S225, a control signal is output to the picture processing unit 80, and, by the representative shot detection means 85, the still shot K (still shot information whose ID is K) is read and acquired from within the still shot information stored in the above-described still shot information storage unit 82.

In the next step S230, a control signal is output to the picture processing unit 80, and, by the representative shot detection means 85, the shot length is calculated from the start/end frame information (refer to above-described FIG. 5) of the above-described acquired still shot K, and it is judged whether or not this shot length is longer than a threshold value THa. This threshold value THa is a value that represents the shortest shot length for selecting a representative shot, and it is set to about 90 frames (equivalent to approximately 3 seconds in time), for example. Furthermore, the value of threshold value THa is not limited thereto, and can also be set to another value. Also, the threshold value THa can be set by time rather than by number of frames. If the shot length of still shot K is longer than the threshold value THa, the judgment is satisfied and the flow moves to the next step S235.

In step S235, a control signal is output to the picture processing unit 80, and, by the representative shot detection means 85, it is judged whether or not there is superimposed text information in the shot segment of the still shot K whose above-described shot length was judged to be longer than the threshold value THa. Specifically, the start/end frame information of still shot K (refer to above-described FIG. 5) and the start/end frame information of the superimposed text information (refer to above-described FIG. 6) detected and stored in the above-described step S220 are compared. If there are overlapping frame regions, it is judged to be superimposed text information, and if there is no overlap, it is judged not to be superimposed text information. If the still shot K is superimposed text information, the judgment is satisfied and the flow moves to the next step S240.

In the next step S240, a control signal is output to the picture processing unit 80, and, by the representative shot detection means 85, the size of the superimposed text (here, the area of the superimposed text region) is calculated based on the superimposed text region information (refer to above-described FIG. 6) of the superimposed text information contained in the shot segment of the above-described still shot K, and it is judged whether or not the size of this superimposed text is larger than a threshold value THb. This threshold value THb is a value that represents the smallest area of superimposed text for selecting a representative shot, and it is set to about 10% of the total frame area, for example. Furthermore, the value of threshold value THb is not limited thereto, and can also be set to another value. Also, the parameter that represents the size of the superimposed text is not limited to the area of the superimposed text region as described above. The area per character (or character region) of superimposed text or the height (vertical dimension) of a character (or character region) and the like can also be used. If the size of the superimposed text is larger than the threshold value THb, the judgment is satisfied and the flow moves to the next step S245.

In step S245, a control signal is output to the picture processing unit 80, and the still shot K is judged as the representative shot by the representative shot detection means 85. Then, the flow moves to the next step S250. Furthermore, if the shot length of the still shot K is below the threshold value THa in the above-described step S230, or if there is no superimposed text information in the still shot K in step S235, or if the size of the superimposed text is less than the threshold value THb in step S240, it moves directly to the next step S250 without the judgments in each step being satisfied.

In step S250, a control signal is output to the picture processing unit 80, and, by the representative shot detection means 85, it is judged whether or not the procedures from the above-described step S225 through step S245 have been performed for all still shots detected in the above-described step S215. That is, for example, in the case where three still shots were detected in the above-described step S215, if the variable K that counts the ID number of still shot information does not reach 2 starting from 0 (refer to above-described FIG. 5), it is deemed that judgment has not been completed for all still shots, and the flow moves to the next step S255 where 1 is added to the variable K, then it returns to the preceding step S225. On the other hand, if the variable K reaches 2 starting from 0 (refer to above-described FIG. 5), it is deemed that judgment has been completed for all still shots, and the flow moves to the next step S260.

In step S260, a control signal is output to the picture processing unit 80, and, by the representative image selection means 86, one frame from the shot segment judged to be the representative shot in the above-described step S245 is selected as the representative image. In this case, because the representative shot is a still shot as described above, any frame in the representative shot is selected as the representative image. Also, if a plurality of representative shots were detected by the representative shot detection means 85, a representative image is selected from any representative shot as described above.

In the next step S265, a control signal is output to the picture processing unit 80, and, by the specification information generating means 87, a frame specification signal that indicates which of the frame images within which of the representative shots is the selected representative image, is generated as the specification information for specifying the representative image selected as described above. Also, the record instruction signal generating means 88 generates a record instruction signal for recording the specification information generated by the above-described specification information generating means 87 to the recording medium D in connection with the corresponding video signal.

In the next step S270, a control signal is output to the picture processing unit 80, and, by the output means 89, the specification information and record instruction signal generated in the above-described step S265 are output to the system control unit 50 together with the picture information input in step 210. With the above, the routine ends.

Furthermore, while in the above a case where one representative image is specified has been described as an example, the present invention is not limited thereto. For example, in the case where there are a plurality of representative shots, one representative image can also be specified from each representative shot, and a plurality of representative images can be specified. In this case, this plurality of representative images are displayed on the display unit 9 as described above, and the operator can select any one of the representative images.

As explained above, the picture processing apparatus (image processing unit in this example) 80 in the present embodiment comprises still shot detection means 81 for detecting a still shot from a video signal provided in the program to be processed; specification means (representative image selection means in this example) 86 for specifying a representative image of the program based on the detection results of the still shot detection means 81; and output means 89 for outputting a signal corresponding to the representative image specified by the specification means 86.

The video signal of the program contains a plurality of shots as a collection of frames that are continuous in time. In general, because the audience of program tends to watch with particular focus when there is a still portion in the program, producers and broadcasters of program often construct scenes that they wish to captivate the attention of the audience and the frames before and after it as still frames (equivalent to a still shot). To respond to this, the present embodiment detects still shots from a video signal by still shot detection means 81, and specifies a representative image of the program accordingly by specification means 86. In this way, because the specified representative image reflects the intentions of the producer or broadcaster described above, it is possible to efficiently extract an image that captivates the attention of the audience (in other words, that well reflects the contents of the program) by making appropriate use of a signal output from the output means 89 that corresponds to the specified representative image. As a result, it differs from the case where a representative image is specified from superimposed text alone, in that a representative image that has substantive meaning can be efficiently acquired.

The picture processing apparatus 80 in the above-described embodiment further comprises specification information generating means 87 for generating specification information for specifying a representative image of the program based on the results of the specification means 86, wherein the output means 89 outputs the specification information as a corresponding signal.

Due to the fact that specification information that corresponds to the specified representative image is output from the output means 89, an image that well reflects the contents of the program can be extracted efficiently using this specification information, and it can be used in various applications using this representative image in external devices outside the processing apparatus.

The picture processing apparatus 80 in the above-described embodiment further comprises first record instruction signal generating means (record instruction signal generating means in this example) 88 for generating a first record instruction signal (record instruction signal in this example) for recording specification information or information connected therewith to the recording medium D in connection with the corresponding video signal, wherein the output means 89 outputs the specification information and the first record instruction signal.

As a result, in the recording apparatus 1, the video signal and its corresponding specification information can be recorded to the recording medium D in a format that interconnects them.

The picture processing apparatus 80 in the above-described embodiment further comprises superimposed text detection means 83 for detecting superimposed text of each frame of the video signal provided in the program, wherein the specification means 86 specifies the representative image based on the detection results of the still shot detection means 81 and the detection results of the superimposed text detection means 83.

Program producers and broadcasters often use superimposed text in scenes that they wish to captivate the attention of the audience and the frames before and after it, To respond to this, in the present embodiment, superimposed text detection is performed by the superimposed text detection means 83, and specification of a representative image is performed by the specification means 86 while including these superimposed text detection results as well, and as a result, an image that well reflects the contents of the program can be more reliably extracted.

Note that the present invention is not limited to the above-described embodiment, and many variations are possible without departing from the scope and technical concept thereof. Such variations are described in order below.

(1) Case where the Picture Information Itself of the Representative Image is Generated and Output

In the above-described embodiment, by the specification information generating means 87, a frame specification signal that indicates which frame image in the representative shot is the selected representative image, is generated as the specification information for specifying the representative image selected by the representative image selection means 86, and this frame specification signal is output to the system control unit 50, but the present invention is not limited thereto. That is, for example, the picture information itself that corresponds to the representative image selected by the representative image selection means 86 can also be generated, and this picture information can be output.

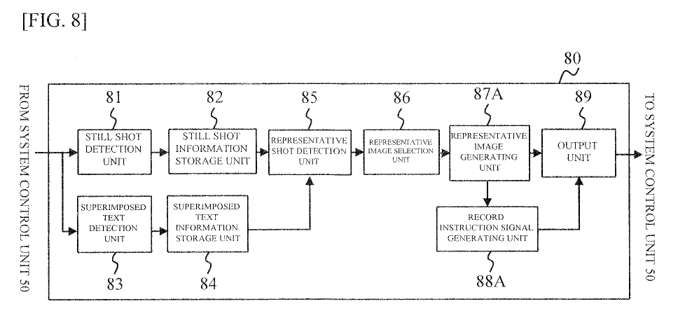

FIG. 8 is a functional block diagram illustrating the functional configuration of the picture processing unit 80 of the present variation, and is equivalent to the above-described FIG. 4. Note that the parts identical to those in FIG. 4 are denoted using the same reference numerals, and descriptions thereof will be omitted.

In FIG. 8, the representative image generating means 87A generates (or can extract from within the picture information) picture information that corresponds to the representative image selected by the representative image selection means 86. Also, the record instruction signal generating means 88A generates a record instruction signal (second record instruction signal) for recording the picture information generated by the above-described representative image information generating means 87A to the recording medium D in connection with the corresponding video signal. Then, the output means 89 outputs to the system control unit 50 the picture information generated by the above-described representative image information generating means 87A and the record instruction signal generated by the record instruction signal generating means 88A.

The picture processing apparatus 80 in the present variation further comprises representative image generating means 87A for generating a representative image of the program from the video signal of the program based on the results of the specification means 86, wherein the output means 89 outputs the representative image as a corresponding signal.

Due to the fact that the specified representative image is generated by the representative image generating means 87A, an image that well reflects the contents of the program can be extracted efficiently, and it can be used in various applications using this representative image that is output from the output means 89.

The picture processing apparatus 80 in the present variation further comprises second record instruction signal generating means (record instruction signal generating means in this example) 88A for generating a second record instruction signal (record instruction signal in this example) for recording a representative image or information connected therewith to the recording medium D in connection with the corresponding video signal, wherein the output means 89 outputs the representative image signal and the second record instruction signal.

As a result, in the recording apparatus 1, the video signal and its corresponding representative image can be recorded to the recording medium D in a format that interconnects them.

(2) Case where Specification of a Representative Image is Performed when Writing to HDD

In the above embodiment, the received program picture information is temporarily written to a hard disk using a hard disk drive 14, after which the representative image specification process is performed by reading the picture information from the hard disk, and then the program picture information is recorded to the recording medium D together with the specified representative image, but this invention is not limited thereto. That is, for example, specification of the representative image can also be performed when the received program picture information is written to the hard disk, and the program picture information can also be written to the hard disk together with the specified representative image.

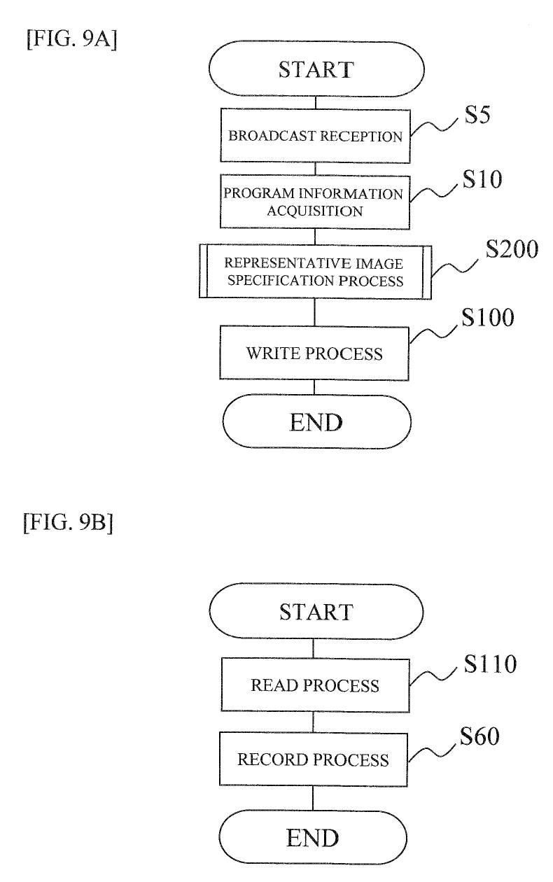

FIG. 9A and FIG. 9B are flowcharts illustrating the control procedure executed by the system control unit 50 of the present variation, and are equivalent to the above-described FIG. 3A and FIG. 3B. Note that the procedures identical to those in FIG. 3A and FIG. 3B are denoted using the same reference numerals, and descriptions thereof will be omitted.

FIG. 9A illustrates the procedure up until writing to the hard disk is performed by the hard disk drive 14. In FIG. 9A, in step S5 and step S10, the video signal and audio signal received by the TV receiver 2 and encoded by the picture/audio encoder unit 4 are taken in, and the predetermined information related to the program being received and recorded is acquired. After that, in step S200, a control signal is output to the picture processing unit 80, and the representative image specification process is performed, in which a representative image is specified from the plurality of frame images contained in the picture information received by the above-described TV receiver 2 and encoded by the picture/audio encoder unit 4 (refer to above-described FIG. 7). Then, in the next step S100, a control signal is output to the disk control unit 13, and the picture information and audio information received in step S5 are written to the hard disk by the hard disk drive 14 together with the representative image information (specification information for specifying the representative image or the picture information itself) generated by the picture processing unit 80.

After that, the flow of FIG. 9B is started when, for example, an operation is performed by the operator via the operating unit 11 to record to the recording medium D. First, in step S110, a control signal is output to the disk control unit 13, and the picture/audio information that contains representative image information that was written and saved to the hard disk in the above-described step S100 is read from the hard disk by the hard disk drive 14. Then, in step S60, a control signal is output to the media write unit 5, and a laser beam is output from the above-described optical pickup, and the recording process is executed, in which the picture/audio information that contains representative image information read from the above-described hard disk is written to the recording medium D. With this, the flow ends.

Furthermore, in the above, it can also be written to the hard disk after the confirmation of the operator is obtained as described above. That is, after the representative image specification process of step S200, the specified representative image is displayed on the display unit 9, and if a selection operation (instruction signal) is input as confirmation of the representative image by the operator via the operating unit 11, the flow moves to the above-described step S100.

The picture processing apparatus 80 in the present variation also exhibits the same advantages as the above-described embodiment.

(3) Case of Recording Directly to Disk while Performing Specification of the Representative Image

In the above embodiment, the received program picture information is temporarily written to a hard disk using a hard disk drive 14, after which the representative image specification process is performed by reading the picture information from the hard disk, and then the program picture information is recorded to the recording medium D together with the specified representative image, but this invention is not limited thereto. That is, for example, without being written to a hard disk, the received program picture information can also be recorded directly to the recording medium D while specification of the representative image is being performed.

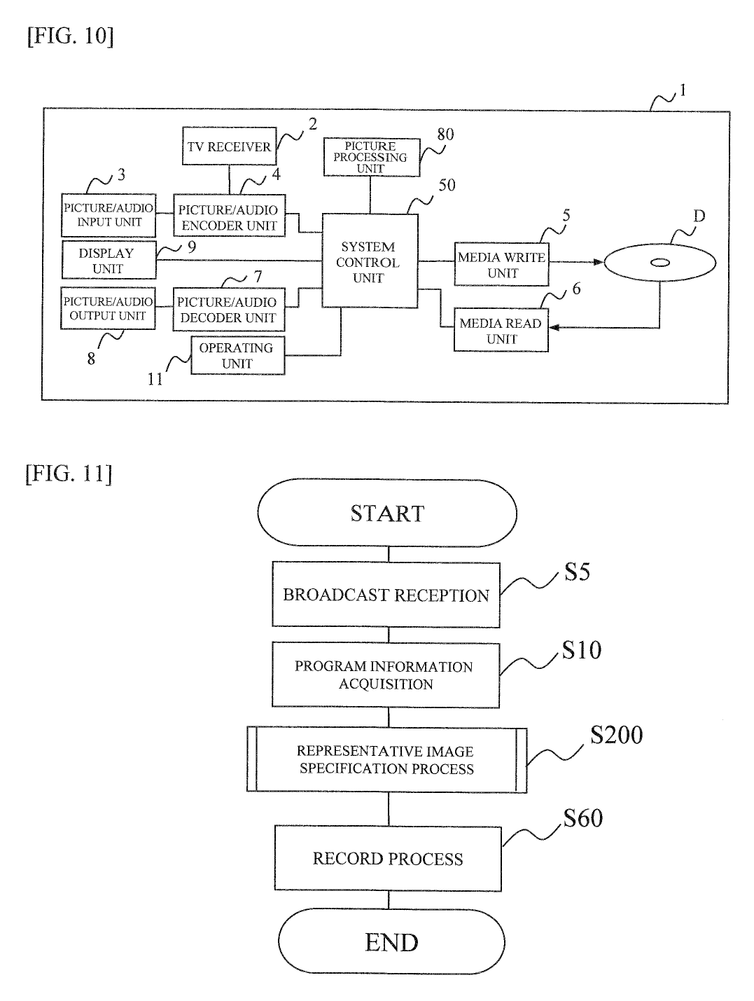

FIG. 10 is a functional block diagram illustrating the functional configuration of the recording apparatus 1 of the present variation, and is equivalent to the above-described FIG. 2. Note that the parts identical to those in FIG. 2 are denoted using the same reference numerals, and descriptions thereof will be omitted. As illustrated in FIG. 10, the recording apparatus 1 of the present variation is configured without a disk control unit 13 or hard disk drive 14.

FIG. 11 is a flowchart illustrating the control procedure executed by the system control unit 50 of the present variation, and is equivalent to the above-described FIG. 3, Note that the procedures identical to those in FIG. 3 are denoted using the same reference numerals, and descriptions thereof will be omitted.

In FIG. 11, in step S5 and step S10, the video signal and audio signal received by the TV receiver 2 and encoded by the picture/audio encoder unit 4 are taken in, and the predetermined information related to the program being received and recorded is acquired. After that, in step S200, a control signal is output to the picture processing unit 80, and the representative image specification process is performed, in which a representative image is specified from the plurality of frame images contained in the picture information received by the above-described TV receiver 2 and encoded by the picture/audio encoder unit 4 (refer to above-described FIG. 7). Then, in the next step S60, the recording process is executed, in which a control signal is output to the media write unit 5, and a laser beam is output from the above-described optical pickup, and picture information and audio information corresponding to the video signal and audio signal received and encoded by the picture/audio encoder unit 4 in step S5, as well as the representative image information (specification information for specifying a representative image or the picture information itself) generated by the picture processing unit 80, are written to the recording medium D. With this, the flow ends.

Furthermore, in the above, recording to the recording medium D can also be performed after the confirmation of the operator is obtained as described above. That is, after the representative image specification process of step S200, the specified representative image is displayed on the display unit 9, and if a selection operation (instruction signal) is input as confirmation of the representative image by the operator via the operating unit 11, the flow moves to the above-described step S60.

The picture processing apparatus 80 in the present variation also exhibits the same advantages as the above-described embodiment.

(4) Case where the Representative Image is Printed

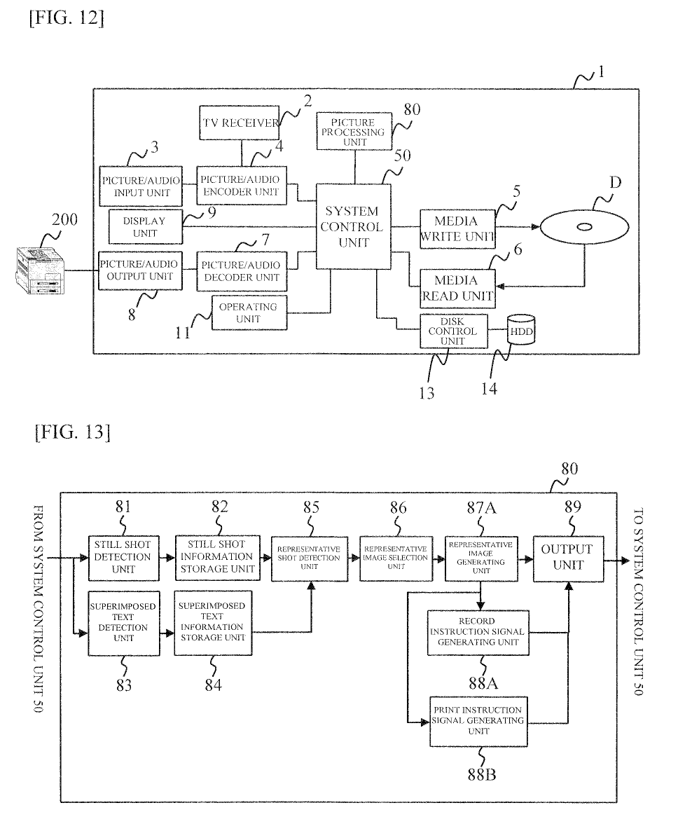

FIG. 12 is a functional block diagram illustrating the functional configuration of the recording apparatus 1 of the present variation, and is equivalent to the above-described FIG. 2. Note that the parts identical to those in FIG. 2 are denoted using the same reference numerals, and descriptions thereof will be omitted. As illustrated in FIG. 12, in the recording apparatus 1 of the present variation, a printer 200 is connected via the picture/audio output unit 8. As a result, the representative image information (here, picture information) generated by the picture processing unit 80 undergoes D/A conversion by the picture/audio decoder unit 7, and is output to the printer 200 via the picture/audio output unit 8, and the representative image can be printed by the printer 200.

FIG. 13 is a functional block diagram illustrating the functional configuration of the picture processing unit 80 of the present variation, and is equivalent to the above-described FIG. 4. Note that the parts identical to those in FIG. 4 are denoted using the same reference numerals, and descriptions thereof will be omitted.

In FIG. 13, the representative image generating means 87A, similar to in the above-described variation (1), generates (or can extract) picture information that corresponds to the representative image selected by the representative image selection means 86. Also, the record instruction signal generating means 88A generates a record instruction signal (second record instruction signal) for recording the picture information generated by the above-described representative image information generating means 87A to the recording medium D in connection with the corresponding video signal. Additionally, print instruction signal generating means 88B generates a print instruction signal for printing the picture information generated by the above-described representative image generating means 87A to a predetermined print medium by a printer 200. Then, the output means 89 outputs to the system control unit 50 the picture information generated by the above-described representative image information generating means 87A and the record instruction signal generated by the record instruction signal generating means 88A, as well as the print instruction signal generated by the print instruction signal generating means 88B.

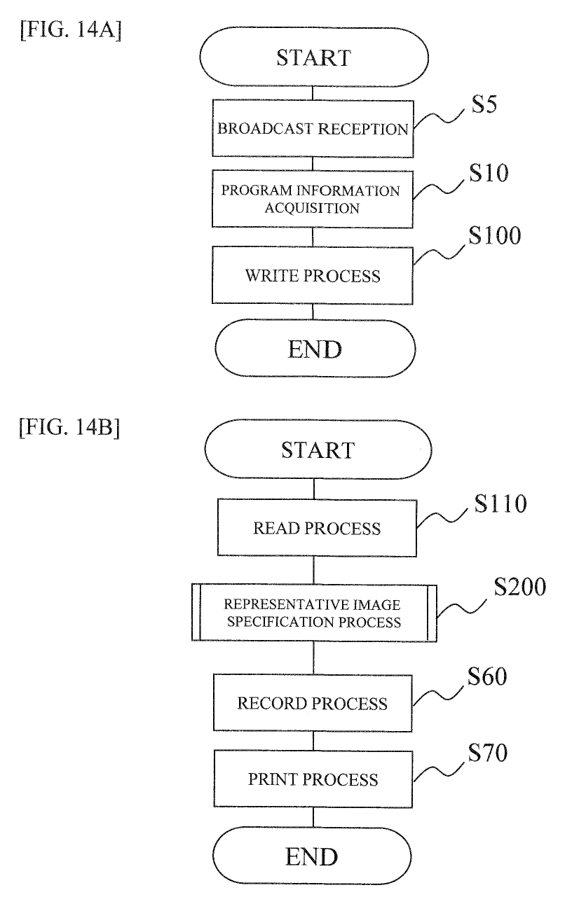

FIG. 14A and FIG. 14B are flowcharts illustrating the control procedure executed by the system control unit 50 of the present variation, and are equivalent to the above-described FIG. 3A and FIG. 3B. Note that the procedures identical to those in FIG. 3A and FIG. 3B are denoted using the same reference numerals, and descriptions thereof will be omitted.

Because FIG. 14A is the same as FIG. 3A, descriptions thereof will be omitted. Also, in FIG. 14B, steps S110-S60 are the same as in FIG. 3B. That is, in step S110, picture/audio information written and saved to the hard disk is read from the hard disk by the hard disk drive 14, and in step S200, a representative image specification process is performed, in which a representative image is specified from the plurality of frame images contained in the picture information within the picture/audio information read from the hard disk (refer to FIG. 7). Then, in step S60, based on a record instruction signal generated by the picture processing unit 80, a recording process is executed, in which picture information and audio information and representative image information (here, picture information) generated by the picture processing unit 80 are written to the recording medium D.

In the next step S70, based on a print instruction signal generated by the above-described print instruction signal generating means 88B, a control signal is output to the above-described picture/audio decoder unit 7, and the representative image information (here, picture information) generated by the picture processing unit 80 undergoes D/A conversion, and is output to the printer 200 via the picture/audio output unit 8. As a result, printing of the representative image by the printer 200 can be performed. Then, the flow ends.

Furthermore, in the above, printing and recording to the recording medium D can also be performed after the confirmation of the operator is obtained as described above. That is, after the representative image specification process of step S200, the specified representative image is displayed on the display unit 9, and if a selection operation (instruction signal) is input as confirmation of the representative image by the operator via the operating unit II, the flow moves to the above-described step S60.

Also, while in the above the representative image is printed by a printer 200 provided externally to the recording apparatus 1, the present invention is not limited thereto. For example, printing means can also be provided, which is able to perform printing on the surface of the recording medium D within the recording apparatus 1, and by this printing means the representative image can be printed on a label on the recording medium D. As a result, a recording medium D by which recorded contents can be easily understood by the user can be realized.

The picture processing apparatus 80 in the present variation further comprises print instruction signal generating means 88B for generating a print instruction signal for printing a representative image or information connected therewith to a predetermined print medium, wherein the output means 89 outputs the representative image signal and print instruction signal.

As a result, the representative image that corresponds to the program can be printed by the printing apparatus (printer in this example) 200.

(5) Case where Chapter (Segments within the Program) Division is Performed

In the above-described embodiment, if a plurality of representative images were selected, that plurality of representative images are displayed on the display unit 9 and the operator can select any one of the representative images, but this invention is not limited thereto, and chapter division of the television images can also be performed, for example.

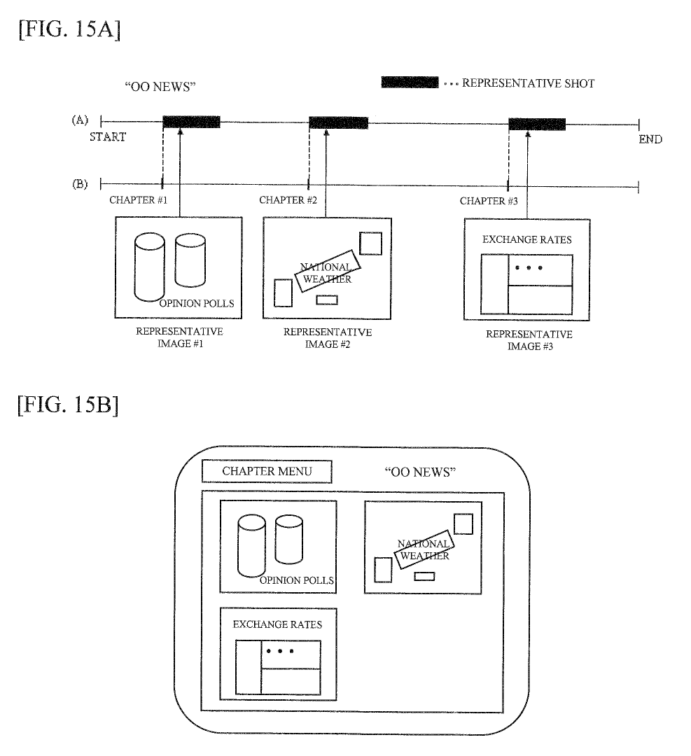

FIG. 15A and FIG. 15B are drawings illustrating a specific example of the present variation. FIG. 15A is a drawing for explaining the procedure by which chapters and their representative images are determined from the picture information of one program, and FIG. 15B is a drawing illustrating an example of a chapter menu.

In FIG. 15A, the flow of the television program is shown on the horizontal axis, where the left end of the axis is the program start and the right end is the program end. In this case, as illustrated by the thick bars of (A) on the top, three representative shots are detected in the picture information of the television program (“OO News” in this example). Based on this, the start position of each chapter (segment within the program) and the representative image that corresponds to each chapter are determined. That is, as illustrated in (B) on the bottom, the start position of each representative shot is used as the start position of each chapter (chapter #1, #2, #3), and the representative image (representative image #1, #2, #3) selected from each representative shot is used as the representative image (thumbnail) of each respective chapter.

As a result, as illustrated in FIG. 15B, a representative image that appropriately expresses the contents of each chapter in the program can be displayed on a menu, and an effective chapter menu that can be easily understood by the user can be realized. Also, if a plurality of representative images were detected, it is not necessary to select and discard as in the above-described embodiment, and therefore the risk of erroneously deleting a representative image that the user would truly want can be reduced.

Furthermore, while in the above the start position of each representative shot is used as the chapter start position, a position other than that, for example, a position that satisfies a fixed condition such as a cut point or silent portion immediately before the representative shot, can also be used as the chapter start position.

(6) Case where Threshold Value of Still Shot Detection is Varied Depending on Program

As described above, as a known still shot detection method, there is a method in which threshold comparison of the differences in luminance histograms is performed. That is, there is a method in which the difference in luminance histograms between the frame itself and the frame before it is calculated for each frame, and segments that fall below a certain threshold value are taken to be still shots. In this case, the above-described threshold value can also be varied depending on the average difference in luminance histograms.

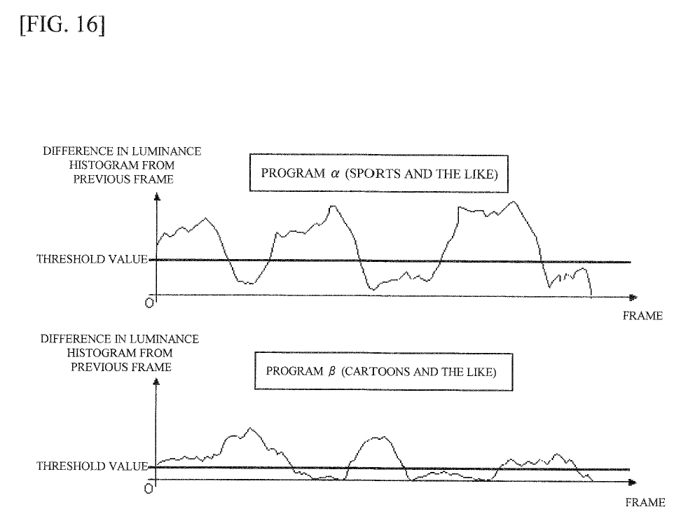

FIG. 16 is a drawing illustrating an example of the case where the threshold value is varied depending on the program. In FIG. 16, the horizontal axis represents frames, and the vertical axis represents the difference in luminance histograms between each frame and the one before it. As illustrated in the drawing, the threshold value is set high for program □ (for example, a sports program) in which the average difference in luminance histograms is relatively large, and the threshold value is set low for program [symbol] (for example, a cartoon program) in which the average difference in luminance histograms is relatively small.

By varying the threshold value depending on the average difference in luminance histograms of the program in this way, for scenes that have a relatively low difference in luminance histograms but are not true still shots, such as scenes where only the mouth moves in a cartoon program, for example, erroneous detection as still shots can be prevented, and the precision of still shot detection can be improved.

Furthermore, while in the above a case where a method of performing threshold comparison of the difference in luminance histograms is used as the still shot detection method has been described as an example, the present invention is not limited thereto. The idea behind varying the threshold value depending on the average degree of stillness in a program can also be applied to the present variation.

(7) Case where CM Portions are Removed from Representative Image Candidates

While the CMs (commercial messages) in the program are not particularly detected in the above-described embodiment, the invention is not limited thereto. CMs in a program can be detected, and still shots detected within a segment judged to be a CM can be removed from the representative shot candidates. Specifically, known CM detection means (not shown) can be provided, and still shots detected in a segment that is judged to be a CM can be eliminated from the representative shot candidates. Also, because two or more still shots that are continuous in time often appear in television commercials, if two or more different still shots that are continuous in time are detected by the still shot detection means 81, those still shots can also be eliminated from the representative shots.

As a result, CM segments that are clearly not suitable as representative images can be eliminated, and the precision of representative shot detection can be improved.

The picture processing unit 80 in the above-described embodiment comprises still shot detection means 81 for detecting a still shot from a video signal provided in the program to be processed; representative image selection means 86 for specifying a representative image of the program based on the detection results of the still shot detection means 81; and output means 89 for outputting a signal corresponding to the representative image specified by the representative image selection means 86.

The video signal of the program contains a plurality of shots as a collection of frames that are continuous in time. In general, because the audience of program tends to watch with particular focus when there is a still portion in the program, producers and broadcasters of program often construct scenes that they wish to captivate the attention of the audience and the frames before and after it as still frames (equivalent to a still shot). To respond to this, the present embodiment detects still shots from a video signal by still shot detection means 81, and specifies a representative image of the program accordingly by representative image selection means 86. In this way, because the specified representative image reflects the intentions of the producer or broadcaster as described above, it is possible to efficiently extract an image that captivates the attention of the audience (in other words, that well reflects the contents of the program) by making appropriate use of signal output from the output means 89 that corresponds to the specified representative image. As a result, it differs from the case where a representative image is specified from superimposed text alone, in that a representative image that has substantive meaning can be efficiently acquired.

1-7. (canceled)

8. A picture processing apparatus, comprising:
a still shot detection unit that detects a still shot from a video signal provided in a program to be processed;
a still shot memory unit that stores still shot information in which reliability calculated based on the results of predetermined threshold comparison is added to said still shot;
a specification unit that specifies a representative image of said program;
an output unit that outputs a signal corresponding to said representative image specified by said specification unit;
a superimposed text detection unit that detects at least one superimposed text of each frame of said video signal provided in said program; and
a superimposed text information storage unit that stores superimposed text information in which predetermined reliability is added to the superimposed text detection results by said superimposed text detection unit; wherein:
said specification unit specifies said representative image based on said still shot information stored in said still shot memory unit and said superimposed text information stored in said superimposed text information storage unit.

9. The picture processing apparatus according to claim 8, further comprising:
a specification information generating unit that generates specification information for specifying the representative image of said program based on the results of said specification unit; wherein:
said output unit outputs said specification information as said signal corresponding to said representative image.

10. The picture processing apparatus according to claim 2, further comprising:
a first record instruction signal generating unit that generates a first record instruction signal for recording said specification information or information connected therewith to a predetermined recording medium in connection with the corresponding said video signal; wherein:
said output unit outputs said specification information and said first record instruction signal.

11. The picture processing apparatus according to claim 8, further comprising:
a representative image generating unit that generates said representative image of said program from the video signal of said program based on the results of said specification unit; wherein:
said output unit outputs said representative image as said signal corresponding to said representative image.

12. The picture processing apparatus according to claim 11, further comprising:
a second record instruction signal generating unit that generates a second record instruction signal for recording said representative image or information connected therewith to a predetermined recording medium in connection with the corresponding said video signal; wherein:
said output unit outputs said representative image signal and said second record instruction signal.

13. The picture processing apparatus according to claim 11, further comprising:
a print instruction signal generating unit that generates a print instruction signal for printing said representative image or information connected therewith on a predetermined printing medium; wherein:
said output unit outputs said representative image signal and said print instruction signal.
